(19) United States
(12) Patent Application Publication
(10) Pub. No.: US 2020/0072360 A1
(43) Pub. Date: Mar. 5, 2020

(54) Sealing structure of a five-dimensional eccentric valve

(71) Applicant: Wenxue Xie, Yangzhou (CN)

(72) Inventor: Wenxue Xie, Yangzhou (CN)

(21) Appl. No.: 16/553,159

(22) Filed: Aug. 27, 2019

(30) Foreign Application Priority Data
Aug. 29, 2018 (CN) 201810998013.0

(51) Int. Cl. F16K 1/226; F16K 5/06

(52) U.S. Cl. CPC F16K 1/2261; F16K 5/0684

(57) ABSTRACT

This utility model relates to a five-dimensional eccentric valve sealing structure. It is comprised of a valve body, valve stem, and disk, wherein the open-close member is positioned inside the valve body, the valve stem is connected to the open-close member, a sealing ring is set on the open-close member, a valve seat is set in the valve body, the valve seat and sealing ring are closed to form a sealing surface which is shaped as an arc. This utility model has the advantage of simple structure. With five-dimensional eccentricity, each radial section of the sealing surface is a normal circular section, which can reduce the opening and closing torque and result in good sealing performance and prolonged valve service life.

### FIELD OF THE INVENTION

This utility model relates to a valve, in particular to a five-dimensional eccentric valve sealing structure.

### BACKGROUND OF THE INVENTION

Ball and butterfly valves are the two most widely-used valves in the world. They are simple and easy to operate, and can cut off the pipeline medium. For the ball valve, the open-close member (ball) is driven by the valve stem, and rotates around the axis of the valve. The ball valve can also be used for fluid regulation and control. In the hard seal V-ball valve, a strong shearing force exists between the V-ball core and the metal valve seat overlaying hard alloy. The ball valve is especially suitable for media containing fibers and tiny solid particles, etc. The multi-way ball valve, on the other hand, not only can flexibly control media confluence, diversion and flow direction switching on pipelines, but also close any channel to connect the other two. Valves of this type are installed horizontally in pipelines. Ball valves are divided into pneumatic, electric, and manual ball valves. The butterfly valve, also called flap valve, is a kind of regulating valve with a simple structure, mainly composed of the valve body, valve stem, butterfly plate, and sealing ring. The valve body is cylindrical, with short axial length and a built-in butterfly plate. Existing butterfly plates and ball valves have serious abrasion, large bearing pressure, poor sealing performance, large opening and closing torque, and short service life.

### Contents of the Utility Model

This utility model aims resolve the above defects through a five-dimensional eccentric valve sealing structure, reducing opening and closing torque, and providing good sealing performance and long service life.

The technical solution adopted by the utility model is as follows.

The solution is comprised of a valve body, valve stem, and open-close member, wherein said open-close member is positioned within the valve body, said valve stem is connected to the open-close member, one side of the open-close member has an annular step, a sealing ring is set on said annular step, said sealing ring is affixed on the open-close member through a pressing ring, and a valve seat is set on the valve body. Said valve seat and the sealing ring are connected to form a sealing surface, which is an oblique elliptical cone normal circle and arc-shaped, part of an elliptical cone which is inclined relative to the center line of the valve flow passage. The plane where the apex of the inclined elliptical cone and the minor axis of the elliptical bottom surface coexist is coplanar with the valve runner centerline, and perpendicular to the valve stem axis centerline. The valve stem axis centerline is eccentrically arranged with the center line of the valve flow passage. The apex of the inclined elliptical cone is eccentrically arranged with the center line of the valve flow passage, and the radial section of the oblique elliptical cone normal circle sealing surface is circular. The circle center of the positive circular section is eccentrically arranged with the center line of the valve flow passage, and lies on the center line of the cone in the oblique elliptical cone. The intersection line of the plane where the apex of the oblique elliptical cone and the minor axis of the elliptical bottom surface coexist, and the arc-shaped sealing surface, is a sealing arc line. The diameter of the positive circular section gradually decreases in dimension from the side close to the valve stem to that opposite. The center of the sealing arc line is eccentrically arranged with the apex of the oblique elliptical cone.

As a further improvement of the above technical solution, said open-close member can be a butterfly plate.

As a further improvement of the above technical solution, said open-close member can be a sphere.

Virtues of the utility model:

This utility model has simple structure characterized by five-dimensional eccentricity. Each radial section of the sealing surface is circular, and the sealing line of the axial section is an arc line, thus resolving the problems of uneven compression at each point of the sealing surface and deformation leakage caused by uneven stress on the sealing surface at high and low temperatures, and further reducing opening and closing torque, with good sealing performance, prolonging the service life of the valve.

### BRIEF INTRODUCTION TO THE DRAWINGS

FIG. 1 is a structural schematic diagram of this utility model.

FIG. 2 is a sectional view of A-A in FIG. 1.

FIG. 3 is a partial enlarged view of B in FIG. 1.

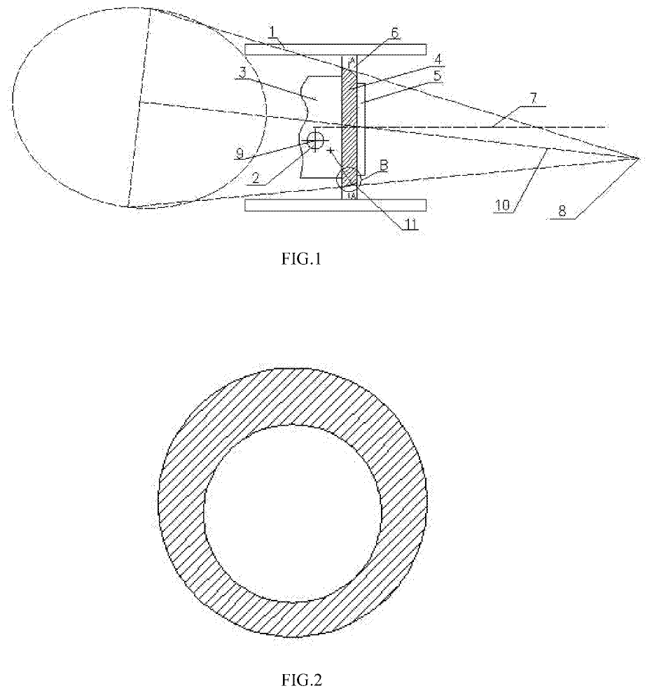

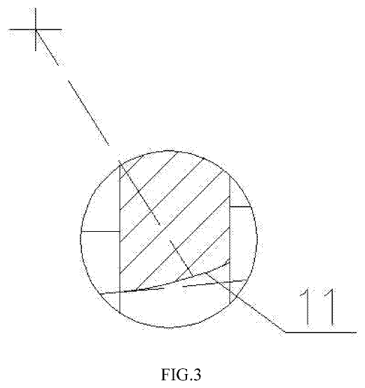

In the FIG. 1 is the valve body, 2 is the valve stem, 3 is the open-close member, 4 is the sealing ring, 5 is the pressure ring, 6 is the valve seat, 7 is the center line of the valve flow passage, 8 is the apex of the inclined elliptical cone, 9 is the apex of the inclined elliptical cone, 10 is the center line of the cone, and 11 is the sealing arc line.

### DETAILED DESCRIPTION OF PREFERRED EMBODIMENTS

The invention relates to a five-dimensional eccentric valve sealing structure, comprised of a valve body 1, valve, stem 2, and open-close member 3, wherein said open-close member 3 is positioned in the valve body 1; said valve stem 2 is connected to the open-close member 3; one side of said open-close member 3 has an annular step; a sealing ring 4 is set upon said annular step; said sealing ring 4 is affixed upon the open-close member 3 through a pressing ring 5; a valve seat 6 is set on the valve body 1; said valve seat 6 and the sealing ring 4 are closed to form a sealing surface; and the sealing surface of the five-dimensional eccentric valve sealing structure is characterized by an oblique elliptical cone normal circle shape. The sealing surface is arc-shaped, a part of an inclined elliptical cone which is inclined relative to the center line 7 of the valve flow passage. The plane where the apex of the inclined elliptical cone 8 and the minor axis of the elliptical bottom surface coexist is coplanar with the valve runner centerline 7, and perpendicular to the valve stem axis center line 9. The valve stem, axis center line 9 is eccentrically arranged with the center line of the valve flow passage 7, the apex of the inclined elliptical cone 8 is eccentrically arranged with the center line of the valve flow passage 7, and the radial section of the oblique elliptical cone normal circle sealing surface is circular. The center of the circle of the positive circular section is eccentrically arranged with the center line of the valve flow passage, the center of the circle of the positive circular section lies on the center line of the cone in the oblique elliptical cone 10. The intersection line of the plane where the apex of the oblique elliptical cone 8 and the minor axis of the elliptical bottom surface coexist, and the arc-shaped sealing surface, is a sealing arc line 11. The diameter of the positive circular section gradually decreases in dimension from the side close to the valve stem 2 to that opposite. The center of the sealing arc line 11 is eccentrically arranged with the apex of the oblique elliptical cone 8.

As a further improvement on the above technical solution, said open-close member 3 can be a butterfly plate.

As a further improvement on the above technical solution, said open-close member 3 can be a sphere.

It should be emphasized that the above is only one embodiment of the utility model, and does not limit this utility model's patent scope. Equivalent structures or process transformations made by using the specification and attached drawings of this utility model, or directly or indirectly used in other related technical fields, are similarly included in this utility model's patent protection scope.

1. The invention relates to a five-dimensional eccentric valve sealing structure, comprised of a valve body, valve stein and open-close member, wherein said open-close member is positioned within the valve body, the valve stem is connected to the open-close member, one side of the open-close member includes an annular step, a sealing ring is arranged on said annular step, the sealing ring is set on the disc through a pressing ring, a valve seat is set in the valve body, said valve seat and the sealing ring are connected to form a sealing surface, and the five-dimensional eccentric valve sealing structure is characterized by a sealing surface that is an oblique elliptical cone normal circle. The sealing surface is arc-shaped, and part of an inclined elliptical cone which is inclined relative to the center line of the valve flow passage, the plane where the apex of the inclined elliptical cone and the minor axis of the elliptical bottom surface coexist is coplanar with the valve runner centerline, and perpendicular to the valve stem axis centerline. The valve stem axis centerline is eccentrically arranged with the center line of the valve flow passage, the apex of the inclined elliptical cone is eccentrically arranged with the center line of the valve flow passage, and the radial section of the oblique elliptical cone normal circle sealing surface is a normal circle section. The center of the circle of the positive circular section is eccentrically arranged with the center line of the valve flow passage, the circle center of the positive circular section is on the center line of the cone in the oblique elliptical cone, the intersection line of the plane where the apex of the oblique elliptical cone and the minor axis of the elliptical bottom surface coexist and the arc-shaped sealing surface is a sealing arc line, the diameter of the positive circular section gradually decreases in dimension from the side close to the valve stem to that opposite it, and the center of the scaling arc line is eccentrically arranged with the apex of the oblique elliptical cone.

2. The open-close member of the five-dimensional eccentric valve sealing structure described in claim 1 is a butterfly plate.

3. The open-close member of the five-dimensional eccentric valve sealing structure described in claim 1 is a sphere.
